(19) United States
(12) Patent Application Publication
(10) Pub. No.: US 2025/0113946 A1
(43) Pub. Date: Apr. 10, 2025

(54) PORTABLE GRILL WITH FOLDING CHIMNEY

(71) Applicant: James A. Rose, Murrysville, PA (US)

(72) Inventor: James A. Rose, Murrysville, PA (US)

(21) Appl. No.: 18/910,210

(22) Filed: Oct. 9, 2024

Related U.S. Application Data
(60) Provisional application No. 63/543,174, filed on Oct. 9, 2023.

(51) Int. Cl. A47J 37/07; F24C 1/16

(52) U.S. Cl. CPC A47J 37/0763; A47J 37/0704; A47J 37/0786; F24C 1/16; A47J 2037/0777

(57) ABSTRACT

The present invention is portable, collapsible grill assembly having a chimney that folds into the base for storage and that folds into a vertical position to ignite the coals. The collapsible grill assembly has foldable legs, a removable grate, and a collapsible lid that can be arranged to create a small, rectangular collapsed grill for storage and transport.

### CROSS-REFERENCE TO RELATED APPLICATION

This application claims priority to U.S. Provisional Application Ser. No. 63/543,174, filed Oct. 9, 2023, which application is incorporated by reference herein in its entirety.

### BACKGROUND OF THE INVENTION

### Field of the Invention

The present invention is an assembly, device, and system for a portable grill and/or for grill with a folding chimney.

### Background of the Invention

The present invention encompasses various embodiments of an assembly, a device, and a system for a portable grill with a folding chimney. The present invention's portable grill works in many outdoor settings but is of particular use in situations in which the grill needs to be easily transported. Examples of such settings include camping, tailgating, vacationing, etc. Most embodiments of the present invention grill can be transported in a standard vehicle and are configured to have a size and weight such that the grill can be carried by a single individual or two or more individuals. Setting up the grill is easy and requires only one or two persons to do it (depending upon the embodiment). Additionally, the relatively compact and portable nature of the present invention grill enables the grill to be stored easily when not in use (such as on a shelf with other camping or tailgate gear).

The present invention grill assembly includes a folding chimney structure. Many of the existing portable grills do not use or incorporate a chimney because a chimney is a relatively large structure that is preferred for grilling but is not necessary for grilling. For portable, collapsible grills, the chimney is often eliminated to reduce the size and weight of the grill. The present invention solves the chimney dilemma by configuring the chimney as a collapsible or foldable structure that sits within the grill base when not in use.

When grilling, the chimney serves as a starter or a tall structure in which the wood or charcoal (all possible fuels, including charcoal, pellets, kindling, paper, cardboard, and wood, are collectively referred to herein as “charcoal” or “coals”) is started. Charcoal starters facilitate the rapid ignition of charcoal. A chimney's design creates an updraft of air and allows for optimal airflow, which helps heat the charcoal quickly and evenly, and makes the use of lighter fluid optional. Additionally, because the charcoal is packed together in or under the chimney for starting (a compact space), one piece of charcoal lights another, etc. more quickly than preparing coals without a chimney acting as a starter. The elimination of lighter fluid has many advantages including (1) improving the flavor of the food; (2) lowering costs associated with purchasing lighter fluid and extra charcoals due to inefficient burning; and (3) improving the environmental impact of the entire process. Chimneys also can conserve charcoal because they require less or no liquid fuel to light. Once hot, the charcoal then can be spread out under the grate or grilling surface. The user can control the grilling heat or temperature by controlling the number of coals spread under the grilling surface and leaving unneeded coals underneath the chimney. Eliminating the need for lighter fluid is preferable for a transportable grill because it eliminates an additional item that has to be packed and it eliminates a hazardous item that otherwise needs to be transported and stored. As will be explained more fully below, the various embodiments of the present invention grill assembly are configured incorporate the advantages of grilling with a charcoal starter in a single portable grill assembly.

While most existing portable, collapsible grills lack any chimney at all, those grills that do have chimneys utilize a pipe-like or tubular chimney that detaches from the grill for transportation and storage. The present invention is a novel portable grill assembly that has a chimney that folds down and into the horizontal base portion of the grill for transport and storage and remains attached to the grill to house hot coals that are not yet needed beneath the cooking surface.

The removable and collapsible parts of the present invention grill contribute to its portability and relatively small storage footprint (relative for the various sizes of the present invention grill assemblies). Additionally, the present invention grills can be designed to utilize multiple grill surfaces for different functions, such as grilling food on one surface while warming food on a different surface. A multi-function grill assembly provides many advantages over the prior art grill structures by maximizing the number of functions a user can get out of one device. Frequently, when transporting a grill, there is a need for the grill to be small enough to be easily transported and stored with all of the other necessary items and yet sufficiently large and multi-functional to maximize the grill's usefulness. As will be explained herein, the present invention grill assembly accomplishes both of those goals.

### BRIEF SUMMARY OF THE INVENTION

One embodiment of the present invention is a grill assembly that has a base, which is made of at least one side and a bottom. This grill assembly also has a chimney that is configured to move from a substantially horizontal position substantially inside of the base to a substantially vertical position along the at least one side of the base. The chimney has a top, a bottom, and at least one side that extends above the base. The chimney functions as a rapid fuel starter, a vertical combustion chamber, and a repository for hot charcoals. This embodiment of a grill assembly also has a removable grate that rests on top of the base for cooking food and a plurality of legs that support the base.

Another embodiment of the present invention is a grill assembly that has a base, having at least one side and a bottom, and a chimney that is configured to pivot from a substantially horizontal position to a substantially vertical position along the at least one side of the base. The chimney has a top, a bottom, and at least one side that extends above the base. A J-shaped slot in the at least one side of the base corresponds to an axial member on the at least one side of the chimney. The axial member is configured to move within the J-shaped slot. At least one grate sits on top of the base for cooking food.

### BRIEF DESCRIPTION OF THE SEVERAL VIEWS OF THE DRAWINGS

To facilitate understanding of the invention, the drawings and description illustrate preferred embodiments thereof, from which the invention, various embodiments of its structures, construction and method of operation, and many advantages, may be understood and appreciated. The drawings are incorporated by reference.

FIG. 1 shows a top-down perspective view of one embodiment of a grill assembly of the present invention with the lid on and the chimney open;

FIG. 2 shows one embodiment of a grill assembly of the present invention with the lid and the grate removed and the chimney partially collapsed;

FIG. 3 shows a fully closed or collapsed grill assembly according to one embodiment of the present invention;

FIG. 4 is a side view of one embodiment of a grill assembly of the present invention with the chimney fully open;

FIG. 5 is a side view of the grill assembly of FIG. 2 with the chimney partially collapsed;

FIG. 6 shows the front-right view of an alternative embodiment of a grill assembly according to the present invention;

FIG. 7 shows the quarter left view of the embodiment of FIG. 6;

FIG. 8 shows a different quarter right view of the embodiment of FIG. 6; and

FIG. 9 shows the assembly of FIG. 6 in the stowed or closed arrangement.

### DETAILED DESCRIPTION OF THE INVENTION

The following describes example embodiments in which the present invention may be practiced. This invention, however, may have a variety of embodiments and the descriptions provided should not be construed as limiting. The following invention may be embodied as systems, assemblies, or devices. The accompanying drawings are hereby incorporated by reference.

The phrases “in some embodiments”, “in one embodiment”, “in various embodiments”, “according to various embodiments”, “in the embodiments shown”, “in other embodiments”, and the like generally mean the particular feature, structure, or characteristic following the phrase is included in at least one embodiment of the present invention and may be included in more than one embodiment of the present invention. In addition, such phrases do not necessarily refer to the same embodiments or to different embodiments.

If the specification states a component, element, part, or feature “may,” “can,” “could,” or “might” be included or have a characteristic, that particular component or feature is not required to be included or have the characteristic.

In this document, the terms “a” or “an” are used, as is common in patent documents, to include one or more than one. In this document, the term “or” is used to refer to a nonexclusive “or” such that “A or B” includes “A but not B,” “B but not A,” and “A and B,” unless otherwise indicated. All publications, patents, and patent documents referred to in this document are incorporated by reference herein in their entirety, as though individually incorporated by reference. If inconsistent usages occur between this document and those documents so incorporated by reference, the usage in the incorporated reference(s) should be considered supplementary to that of this document; for irreconcilable inconsistencies, the usage in this document controls.

For purposes of the description hereinafter, the terms “upper”, “lower”, “right”, “left”, “vertical”, “horizontal”, “top”, “bottom”, “lateral”, “longitudinal”, and derivatives thereof shall relate to the invention as it is oriented in the figures. However, it is to be understood that the invention may assume alternative orientations, variations, and step sequences, except where expressly specified to the contrary. It also is to be understood that the specific devices and processes illustrated in the attached drawings and described in this specification are simply exemplary embodiments of the invention. Hence, specific dimensions and other physical characteristics related to the embodiments disclosed herein are not to be considered as limiting.

As used herein, the terms “pivot” and “pivot point”, when used as nouns (and “pivotably” and “foldably” when used as an adjective) mean a structural and functional connection between at least two components which allows at least partial rotation of the at least two components relative to one another. For example, a pivot between a chimney and a side of the grill assembly means a physical connection between these two parts that permits at least partial rotation of the chimney relative to the side of the grill, and vice versa. The pivot may include a hole in one or both parts and an axial member extending through the hole(s) to constrain the two parts to each other about a rotational axis. The axial member may include a rod, pin, bolt, screw, bearing, bushing, wheel, or combination thereof to facilitate rotation of the first and second links relative to each other. A pivot may be created or achieved by using one or more hinges or hinge-type mechanisms or structures. While the disclosure has been described in detail and with reference to specific embodiments thereof, it will be apparent to one skilled in the art that various changes and modifications can be made thereto without departing from the spirit and scope of the embodiments. Thus, it is intended that this application covers modifications and variations of this disclosure provided they come within the scope of the appended claims and their equivalents.

Similarly, the terms “hinge” and “hinged”, etc. mean a structural and functional connection between at least to components which allows for at least partial rotation of the two components relative to one another with that rotation having a secure limit or stopping point. There are many mechanical ways to achieve this movement, including but not limited to the use of one or more hinges, and all such mechanical alternatives are included within the use of the word “hinge” and variations thereof. Again, while the disclosure has been described in detail and with reference to specific embodiments thereof, it will be apparent to one skilled in the art that various changes and modifications can be made thereto without departing from the spirit and scope of the embodiments. Thus, it is intended that this application covers modifications and variations of this disclosure provided they come within the scope of the appended claims and their equivalents.

While the disclosure has been described in detail and with reference to specific embodiments thereof, it will be apparent to one skilled in the art that various changes and modifications can be made thereto without departing from the spirit and scope of the embodiments. Thus, it is intended that this application covers modifications and variations of this disclosure provided they come within the scope of the appended claims and their equivalents.

It is to be understood that the invention may assume alternative variations and step sequences, unless specified to the contrary. It also is to be understood that the specific devices and processes illustrated in the attached drawings and described in this specification are simply exemplary embodiments of the invention. Hence, specific dimensions and other physical characteristics related to the embodiments disclosed are not to be limiting.

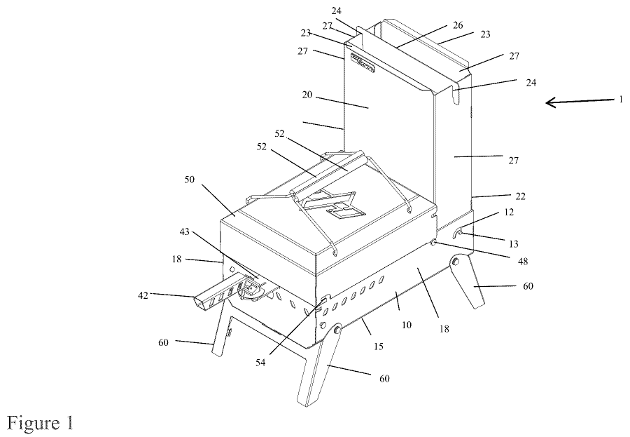

FIGS. 1 through 5 illustrate one embodiment of a portable grill assembly 1 with a folding chimney 20 according to the present invention. As shown in FIG. 1, this embodiment of a portable grill assembly 1 of the present invention has a rectangular base 10 having four sides 18 and a bottom 15, which holds the hot coals over which the food is cooked. Foldably or pivotably attached to two of the sides 18 of the base 10 is a chimney 20. In one embodiment of the present invention, the chimney 20 is approximately the same shape as the base 10 but slightly smaller so that the chimney 20 can fold, pivot, or collapse into the base 10 for storage or transport. However, it will be obvious to one skilled in the art that various embodiments of the present invention can incorporate chimneys 20 of various shapes and sizes as long as those chimneys 20 satisfy the other requirements of the invention, namely, that they are configured to fold into the base 10 for transport and storage and act as a starter to heat the charcoal before the charcoal is spread under the grate or cooking surface 40.

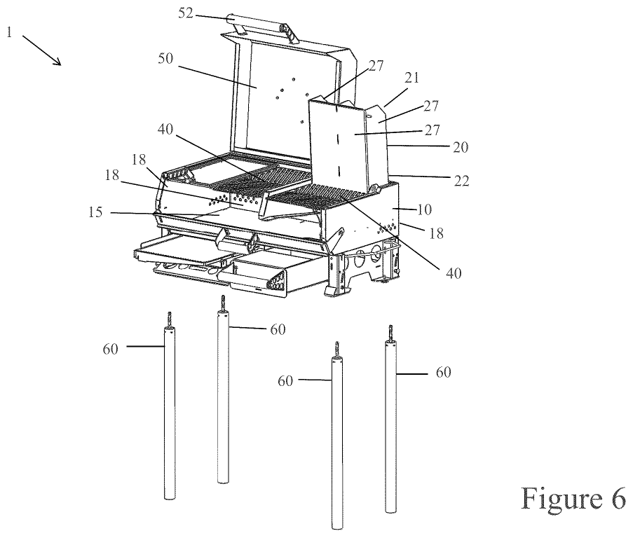

The base 10 of the grill assembly 1 can have a wide variety of shapes and sizes. The base 10 can be rectangular with four connected sides 18 or it can have one continuous side 18 or any number greater than one. The base 10 can be circular in nature having one side 18, but more commonly will have four or more sides 18. Various embodiments of the base 10 can have more than four sides 18 or fewer and for any of those embodiments, the sides 18 can be individual pieces that are connected to one another and to the base 10 as is known in the art or one continuous side 18 that is bent to the desired shape and size. Similarly, the sides 18 of the grill assembly 1 can be manufactured separate from and then connected to the bottom 15 as is known in the art, or the bottom 15 can be manufactured of a solid piece of material (like sheet metal) that is bent to create connected or continuous sides 18. It will be obvious to one skilled in the art that there are many ways to design, configure, and manufacture a base 10 of a wide variety of shapes and sizes that is comprised of at least one side 18 connected to a bottom 15, which together create an area in which to hold hot coals under the chimney 20 and the cooking grate or cooking surface 40 (used interchangeably herein). Another embodiment of a base 10 with sides 18 and a bottom 15 is illustrated in FIGS. 6 through 9.

As described above, the base 10, and the overall grill assembly 1, can be made in a wide variety of sizes and shapes without any real limitation on the overall dimensions. In one preferred embodiment, the base 10 and the overall grill assembly 1 are configured to be movable by one person and transportable in most passenger vehicles. Other embodiments include grill assemblies 1 that come in the wide variety of sizes that one sees in residential grills and smokers currently on the market. Other versions can be as large as traditional commercial grills and smokers. The present invention is not confined to specific dimensions or size requirements and the novel and useful structural elements of the present invention can be incorporated into larger grill designs that require multiple people to move and deploy them. Many of the advantages remain even for grill assemblies 1 that require multiple people to move them, namely, the grill assemblies 1 of the present invention still disassemble as explained herein and fold to smaller sizes for transport and storage and have all of the benefits of grilling or smoking with a chimney 20.

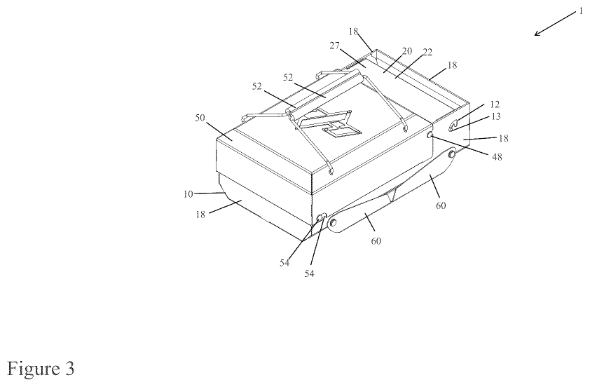

FIG. 1 shows one embodiment of a grill assembly 1 of the present invention with the chimney 20 in the deployed, upright, unfolded, or vertical position and a lid 50 covering the grate or cooking surface 40 and a portion of the base 10. In one embodiment of the present invention, the lid 50 has at least one lid handle 52 to facilitate moving the lid 50 onto and off of the base 10. In some embodiments, the lid 50 secures to the base 10 so that the lid handle 52 can be used to carry the entire grill assembly 1 (illustrated in FIG. 3). This connection between the lid 50 and the base 10 can be accomplished by a wide variety of attachment mechanisms 54 known to one skilled in the art including but not limited to one or more corresponding hooks and slots, various latching mechanisms, or various locking mechanisms. FIG. 3 shows one embodiment of the lid attachment mechanism 54 in the form of a slot 54 on the lid 50 that slides over and catches on a rivet 54 on the base 10. In this embodiment, the lid 50 is slightly larger than the base 10 and slides over the base 10 and secures in place. In one embodiment, when the grate 40 is in place, the lid 50 sits on the grate extension 43 and, optionally, on at least two pins 48 sticking out of the base 10 to support the lid 50. Other lid support structures 48 can be implemented to support the lid 50 when it sits on the base 10. In one embodiment of the present invention, the lid 50 is configured to collapse so that it becomes smaller and easier to store. In some embodiments of the present invention, the lid handle(s) 52 is collapsible or able to fold or move closer to the rest of the grill assembly 1 for more efficient transport and storage.

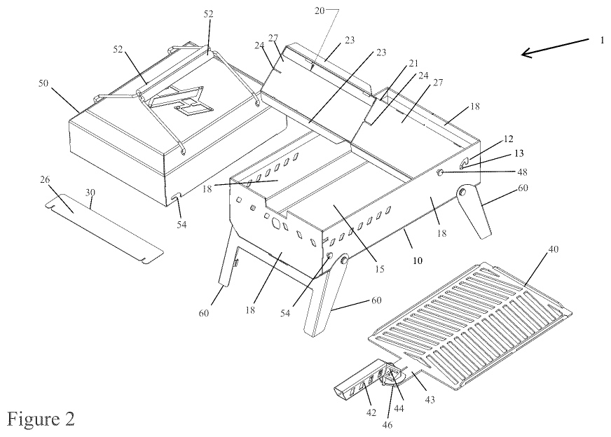

Illustrated more clearly in FIG. 2, the grate or cooking surface 40 (used interchangeably herein) has a grate handle 42 that enables a user to lift the grate 40 (particularly when it is hot) off of the base 10 to access the charcoal underneath. One embodiment of a grate handle 42 is illustrated in FIG. 2. This particular embodiment of a grate handle 42 rotates into position and locks with a spring-loaded latch 44. The spring-loaded latch 44, or similar structure, enables the user to remove the grate handle 42 from the grate 40 and to store the grate handle 42 inside of the base 10 for more efficient transport and storage.

Another optional storage configuration for a grate handle 42 can be configured to have the grate handle 42 insert into or connect to an aperture 46 on the grate 40. Instead of fully removing the grate handle 42 for storage, the grate handle 42 can be configured to turn or be attached in a reverse position so that it extends over the grate 40 instead of away from the grate 40 for storage or transport.

In the preferred embodiments, the grate handle 42 is made of a heat resistant material or coated in a heat resistant material. Another alternative, to make it safer to touch the grate handle 42 when it is hot, is the use of an optional heat resistant sleeve or coating for the grate handle 42 that better enables the user to lift the grate 40 using the handle 52 without getting burned by a hot handle 52. Materials for an optional handle sleeve include silicon, cottons, and quilted materials such as those used to make standard potholders. The present invention grill assembly 1 can be used with a wide variety of fuel sources including charcoal, pellets, and wood, all of which are referred to herein as “coals”.

For various embodiments of the present invention, the chimney 20 has a top 21, a bottom 22, and at least one side 27 that extends upwards beyond the base 10. In various embodiments, and as illustrated in the accompanying Figures, the chimney 20 has four sides 27. Similar to the base 10, the chimney 20 can be rectangular with four connected sides 27 or it can have one continuous side 27 or any number greater than one. The chimney 20 can be circular in nature having one side 27, but more commonly will have four or more sides 27. Various embodiments of the chimney 20 can have more than four sides 27 or fewer and for any of those embodiments, the sides 27 can be individual pieces that are connected to one or one continuous side 27 that is bent to the desired shape and size. The chimney 20 of these various embodiments can be configured to serve at least three functions, namely, (1) acting as a rapid fuel starter, (2) acting as a vertical combustion chamber, and (3) acting as a repository for hot charcoal. The benefits of incorporating a combustion chamber and a rapid fuel starter into grilling have been explained in the Background section and are known in the art. By locating the chimney 20 along one side of the base 10, the chimney 20 functions to keep ignited coals hot until they are needed under the cooking surface or grate 40. This novel arrangement creates a portable grill assembly 1 with an attached chimney 20 that serves the functions of a chimney 20 and of a charcoal starter without the need to transport and use a separate charcoal starter. Finally, there is the additional benefit of configuring the parts of the grill assembly 1, and specifically the chimney 20, to create a repository for ignited charcoal to stay hot until needed for grilling.

The bottom 22 of the chimney 20 is near the base 10 and the coals. The top 21 of the chimney 20 can have a variety of useful configurations. The chimney top 21 can be configured merely to have a standard chimney opening for the circulation of air and smoke from the burning charcoal. However, in the alternative, the chimney top 21 can have a variety of configurations and accessories that enable it to be used for the cooking, heating, or warming of food, by essentially creating a chimney cooking surface 30. In one embodiment, the chimney top 21 can be configured with at least two support structures 23 (or flanges 23) which can be used to support a dish, a pot, or a detachable chimney heating surface 26 (such as a chimney-sized grate 26), which itself can support a dish, a pot, or food. In FIGS. 1, 2, 4, and 5, the support structures 23 are flanges 23, upon which any food surface or cooking pot, pan, or dish could rest. This enables the chimney top 21 to function as an additional cooking or heating surface 30 to maximize the usefulness of a relatively compact portable grill assembly 1.

FIGS. 1, 2, 4, and 5 illustrate one embodiment of a chimney top 21 that is configured to provide additional support for cooking vessels or food vessels. As shown, the addition of a chimney top grate 26, in this instance an additional plate or piece of heat resistant material, slides into two slots 24 in the chimney top 21 to provide additional support for any pot, bowl, plate, etc. to sit on the chimney top 21 and receive the heat that is exiting the chimney 20. In other embodiments, the chimney top grate 26 could be a traditional grate or cooking surface. Again, the chimney heating surface 26 is intended primarily to support food or a container of food so that the heat rising out of the chimney 20 can be used to keep the food warm.

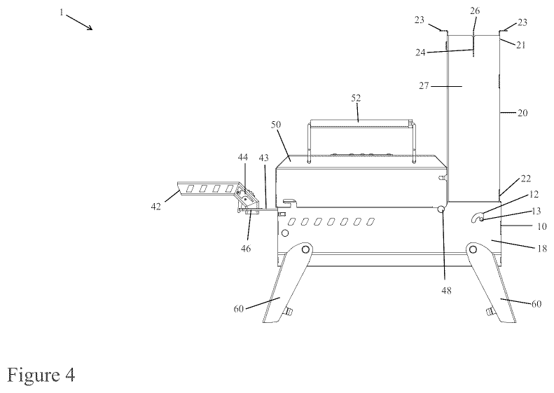

FIG. 1 illustrates one embodiment of a grill assembly 1 with a rectangular base 10. A chimney 20 extends upward from one end of the base 10. The top 21 of the chimney 20 has both flanges 23 and a chimney grate 26 sitting within two slots 24. The chimney bottom 22 pivotably connects to the base 10 by way of a J-shaped slot 12 on each of two opposing sides of the base 10 and two corresponding axial members 13 that move withing the J-shaped slots 12 to enable the chimney to pivot or fold between and open and closed position. Also shown in FIG. 1, is a lid 50 sitting on top of the base 10 and a handle 42 extended from the grate 40 that is beneath the lid. Finally, the grill assembly 1 illustrated in FIG. 1 has four, pivotable or folding, legs 60 that are shown in the open or deployed position. FIG. 4 is a side view of the grill assembly of FIG. 1. Variations of the present invention can be configured to work with no legs or two or more legs 60, depending upon the design of the legs 60 and the grill assembly 1.

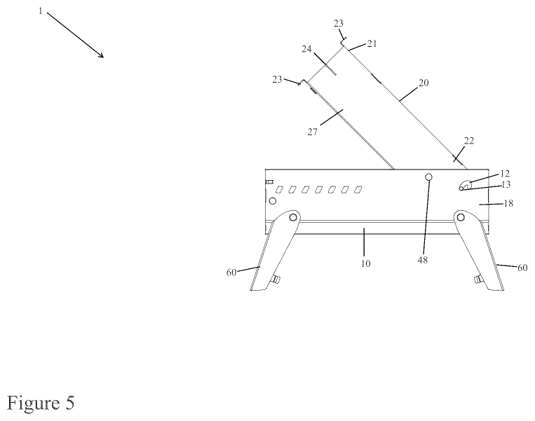

FIG. 2 shows the grill assembly 1 of FIG. 1 with the lid 50 removed. Both FIGS. 1 and 2 show one embodiment of the grill assembly 1 with foldable legs 60 deployed. In one embodiment of the present invention, the legs 60 fold under and against the base 10 to provide for a more compact and easily transported collapsed grill assembly 1. However, alternative embodiments of the present invention can be configured with stationary legs 60 that do not fold up and under the base 10 or with legs 60 that fully detach from the base 10 (see FIG. 6). FIG. 2 also shows the grate 40 removed from the base 10 and the chimney grate 26 removed from the chimney 20. As illustrated in FIG. 2, the chimney 20 is partially closed (or partially opened) and can pivot within the J-shaped slots 12. FIG. 5 is a side view of the grill assembly 1 of FIG. 2.

FIGS. 1 and 2 show a crescent-shaped or J-shaped slot 12 in one side of the base 10 that connects to an axial member 13 on one corresponding side of the chimney 20. This slot 12 and axial member 13 pair is repeated on the opposite side of the base 10 and chimney 20. The slots 12 and axial members 13 enable the chimney 20 to fold into and out of the base 10 without the use of any more complicated parts or structures. The axial member(s) 13 moves or travels within the slot(s) 12. This pairing facilitates a partial rotation of the chimney 20 with respect to the base 10 that enables the chimney 20 to easily fold into the base 10 for storage and to rotate into a vertical position for use. The crescent shaped or J-shaped slot 12 in at least one of the sides of the grill base 10 provides a track for the chimney 20 to travel and then lock in position without additional parts. The novel shape of the slot 12 holds the chimney 20 in the open position. The many benefits of a having a chimney 20 attached to a portable grill base 10 of the present invention are attainable with slots 12 of other shapes and configurations and with attachment mechanisms between the chimney 20 and the base 10 that do not use a slot 12 and axial member 13. All such pivotable connections between the chimney 20 and base 10 are included within the scope of the present invention. However, the crescent or J-shaped slot 12 illustrated in FIGS. 1 through 5 and 9 has the additional benefit of securing the chimney in the open position without any additional mechanical structures beyond the shape of the slot 12 and an axial member 13 to sit or move within and connect to the slot 12.

FIG. 3 shows one embodiment of a fully collapsed and closed grill assembly 1 of the present invention. To collapse this embodiment of a grill assembly 1, in no particular order, the legs 60 fold up and under the base 10. The chimney 20 folds down inside the base 10. The lid 50 can be placed on top of and connected to the base 10. As is shown in FIG. 3, in its fully collapsed state, the grill assembly 1 of the present invention becomes a smaller rectangular box that is easy to transport and store.

The various parts of the present invention can be made from a wide variety of materials. Some of the primary factors in choosing materials for the base 10, the chimney 20, the grate 40, and the lid 50 are heat or fire resistance, durability to fire, and durability to the environmental elements. For example, preferred embodiments of the present invention will be comprised of one or more materials that are both heat resistant and resistant to corrosion. Some preferred materials for these parts include one or more of the following: stainless steel, carbon steel, aluminum, titanium, or other similar materials. The grate 40 also should be made from a food-safe material to enable grilling of food directly on the grate 40. In one preferred embodiment, the grate handle 42 and the lid handle 52 should be made from or covered in a heat resistant material that will enable the user to grasp them when the attached structures are hot. Examples of such materials include wood, high temperature plastic, silicon, etc.

As mentioned previously, there are numerous advantages to the novel grill assembly 1 of the present invention. First, the foldable and able-to-be disassembled nature of the grill assembly 1 enables it to be manufactured and then packed into a small package (bag, box, etc.) with all of its parts, which decreases the amount of shipping and storage space the grill assembly 1 occupies prior to consumer purchase. The configuration of the chimney 20 enables the coals to burn vertically, which substantially speeds up the process of heating the coals as well as making it very easy to light them (employing the same mechanics as a chimney starter). The hot coals are then raked out into the base 10 for use. The vertical chimney 20 enables all of the advantages of using a chimney starter for a grill, namely, (i) faster ignition of the coals; (ii) ignition without the use of lighter fluid; (iii) optimizing airflow around the coals to help heat the coals quickly and evenly; (iv) the elimination of lighter fluid improves the flavor of the food and the environmental impact of the entire process; and (v) the user can move the heated coals around to better control the grilling temperature.

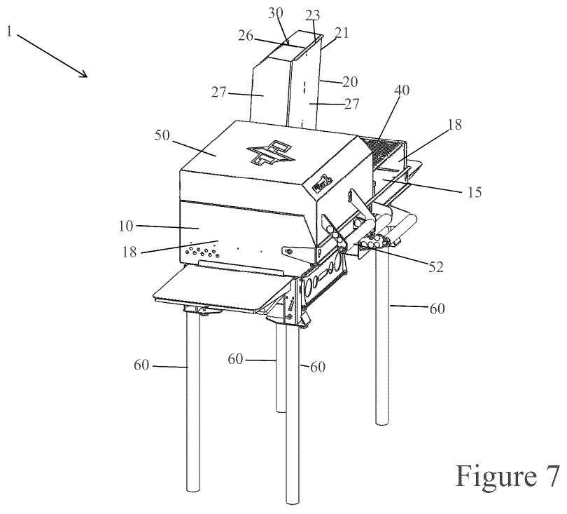

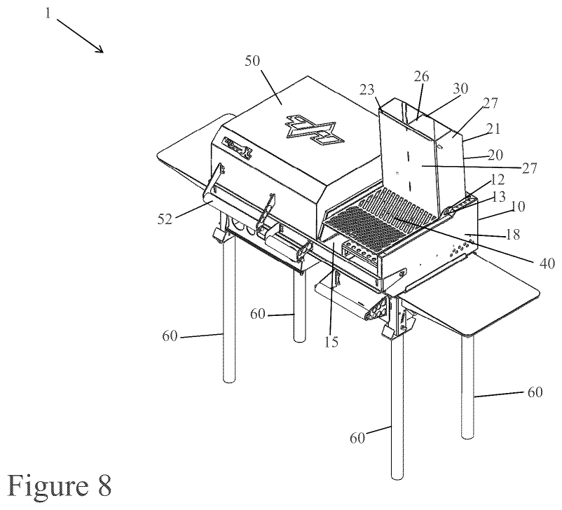

While the present invention has been described with reference to the embodiments illustrated in FIGS. 1 through 5, the novel elements of the invention can be incorporated into grill assemblies of a wide variety of shapes, sizes, and configurations. The incorporation of a folding chimney 20 into a grill assembly 1 of a variety of shapes and sizes, wherein the chimney 20 remains attached to the grill assembly 1 and can be unfolded, opened, or deployed for heating charcoal and cooking and then closed or folded when not in use, provides to grill assemblies 1 of all shapes, sized, and configurations the benefits described herein related to having an associated chimney 20. FIG. 6 through 9 illustrate one alternative embodiment of a grill assembly 1, which has a very different structure from the grill assembly 1 of FIGS. 1 through 5. As illustrated in FIGS. 6 through 9, on a larger grill assembly 1, with a larger or even multiple cooking surfaces 40, a chimney 20 can be configured along a portion of the grill base 10 to provide an area for starting coals and keeping them hot until they need to be moved beneath the cooking surface 40. FIG. 6 shows the chimney 20 configured along two sides 18 of the base 10 and attached to one of those sides 18 via a slot 12 and axial member 13 combination. One embodiment of the present invention is configured with one slot 12 on one side 18 of the base 10 that corresponds to one axial member 13 on the respective side 27 of the chimney 20. The chimney 20 in FIG. 6 is in the open position. FIG. 6 also illustrates a lid 50 which does not cover the chimney 20, but which covers the cooking surface 40 adjacent to the chimney 20. FIG. 7 is the quarter left view of FIG. 6 with the lid 50 closed over a portion of the cooking surface 40 that will not be covered by the closed or folded chimney 20. FIG. 8 shows the grill assembly 1 of FIG. 7 from the opposite perspective.

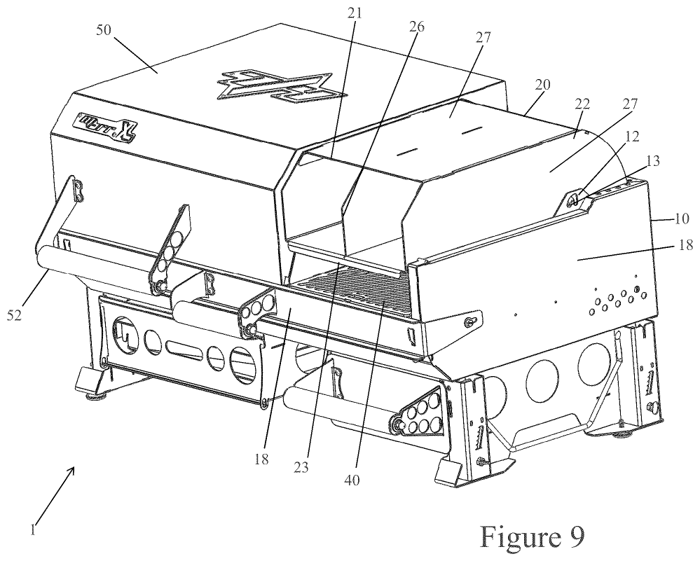

FIG. 9 illustrates the closed or stowed configuration of the grill assembly of FIGS. 6 through 8. For this embodiment of a grill assembly 1, the legs 60 are removeable, instead of foldable (see FIG. 6). The chimney 20 folds down over part of the cooking surface 40. The lid 50 covers the remaining cooking surface 40.

While the disclosure has been described in detail and with reference to specific embodiments thereof, it will be apparent to one skilled in the art that various changes and modifications can be made therein without departing from the spirit and scope of the embodiments. Thus, it is intended that the present disclosure covers all modifications and variations of this disclosure provided they come within the scope of the appended claims and their equivalents. Among other things, the following invention may be embodied as methods or devices. The detailed descriptions of the various embodiments of the present invention should not be taken in a limiting sense.

1. A grill assembly, comprising:
a base having at least one side and a bottom;
a chimney that is configured to move from a substantially horizontal position substantially inside of the base to a substantially vertical position along the at least one side of the base, wherein the chimney has a top, a bottom, and at least one side that extends above the base and the chimney functions as
a rapid fuel starter,
a vertical combustion chamber, and
a repository for hot charcoals;
a removable grate that rests on top of the base; and
a plurality of legs that support the base.

2. The grill assembly of claim 1, wherein the at least one base side has at least one slot that corresponds to an axial member on the at least one chimney side, wherein the chimney pivots from the horizontal position to the vertical position by way of the axial member moving within the slot.

3. The grill assembly of claim 2, wherein the at least one slot is J-shaped.

4. The grill assembly of claim 2, wherein the base is rectangular and has two pairs of opposing sides and wherein the chimney is rectangular and has two pairs of opposing sides, and wherein two opposing base sides each have a slot that corresponds, respectively, to and interacts with an axial member on each of two corresponding opposing chimney sides.

5. The grill assembly of claim 4, wherein the slots are J-shaped.

6. The grill assembly of claim 4, further comprising two support structures attached to two opposing sides of the chimney top, wherein the support structures create a cooking surface on the chimney top.

7. The grill assembly of claim 4, also comprising a cooking surface at the top of the chimney.

8. The grill assembly of claim 7, wherein the cooking surface is a chimney grate.

9. The grill assembly of claim 8, wherein the chimney grate is configured to sit within one slot on each of two opposing chimney sides.

10. The grill assembly of claim 1, further comprising a lid that is configured to fit over the base and the chimney when the chimney is in a substantially horizontal position within the base and wherein the lid is configured to secure to the base.

11. The grill assembly of claim 1, wherein the base is configured in size and weight to be carried by a single person.

12. The grill assembly of claim 1, wherein the base is configured to hold hot charcoals under the removable grate and under the chimney.

13. The grill assembly of claim 1, wherein the chimney is configured both to enable the rapid ignition of charcoal beneath the chimney and to store heated charcoal towards one side of the base until the charcoals are moved under a cooking grate.

14. A grill assembly, comprising:
a base having at least one side and a bottom;
a chimney that is configured to pivot from a substantially horizontal position to a substantially vertical position along the at least one side of the base, wherein the chimney has a top, a bottom, and at least one side that extends above the base;
a J-shaped slot in the at least one side of the base;
an axial member on the at least one side of the chimney configured to move within the J-shaped slot; and
at least one grate that sits on top of the base.

15. The grill assembly of claim 14, further comprising at least two legs that support the base.

16. The grill assembly of claim 14, wherein the base is rectangular and has two pairs of opposing sides, and wherein the chimney is rectangular and has two pairs of opposing sides.

17. The grill assembly of claim 14, further comprising two support structures attached to two opposing sides of the chimney top, wherein the support structures create a cooking surface on the chimney top.

18. The grill assembly of claim 14, further comprising cooking surface at the top of the chimney.

19. The grill assembly of claim 18, wherein the cooking surface is a chimney grate.

20. The grill assembly of claim 18, wherein the chimney grate is configured to sit within one slot on each of two opposing chimney sides.
